(19) United States
(12) Patent Application Publication
(10) Pub. No.: US 2026/0093424 A1
(43) Pub. Date: Apr. 2, 2026

(54) IMAGE FORMING APPARATUS AND CONTROL METHOD FOR IMAGE FORMING APPARATUS

(71) Applicant: SHARP KABUSHIKI KAISHA, Sakai City (JP)

(72) Inventor: Yuhko KANEMOTO, Sakai City (JP)

(21) Appl. No.: 19/335,232

(22) Filed: Sep. 22, 2025

(30) Foreign Application Priority Data
Sep. 27, 2024 (JP) 2024-168648

(51) Int. Cl. G06F 3/12

(52) U.S. Cl. CPC G06F 3/121; G06F 3/1234

(57) ABSTRACT

An image forming apparatus of the disclosure includes a restriction member that restricts user access to the inside of a housing in accordance with an operation state; a display that displays guidance including an operating method related to the restriction member for resolving an event hindering execution of a job when the event occurs; and one or more controllers that control the execution of the job, in which the one or more controllers restrict the execution of the job until the one or more controllers receive a confirmation instruction indicating that a message regarding the movement of the housing has been confirmed by the user, after the event is resolved based on the guidance when the movement of the housing is involved in resolving the event.

### CROSS-REFERENCE TO RELATED APPLICATION

The present application claims priority from Japanese Application JP2024-168648, the content of which is hereby incorporated by reference into this application.

### BACKGROUND OF THE INVENTION

### 1. Field of the Invention

The disclosure relates to an image forming apparatus and a control method for an image forming apparatus.

### 2. Description of the Related Art

For example, in the related art, it is known that when a jam occurs in a sheet transport path provided on the rear side of an apparatus, the entire apparatus may need to be moved in order to clear the jam.

It is also known that an installation situation of an image forming apparatus is determined when a jam occurs, an indication that the apparatus needs to be moved is displayed on a jam release screen when the apparatus needs to be moved, and a “Press when movement is complete” button is displayed when the next action is required after the apparatus is moved.

### SUMMARY OF THE INVENTION

An object of the disclosure is to provide an image forming apparatus and a control method for an image forming apparatus capable of appropriately addressing an event such as a jam that occurs.

An image forming apparatus according to the disclosure includes a restriction member that restricts user access to the inside of a housing in accordance with an operation state; a display that displays guidance including an operating method related to the restriction member for resolving an event hindering execution of a job when the event occurs; and one or more controllers that control the execution of the job, in which the one or more controllers restrict the execution of the job until the one or more controllers receive a confirmation instruction indicating that a message regarding the movement of the housing has been confirmed by the user, after the event is resolved based on the guidance when the movement of the housing is involved in resolving the event.

A control method for an image forming apparatus according to the disclosure is a control method for an image forming apparatus including a restriction member that restricts user access to f the inside of a housing in accordance with an operation state, the method including: displaying guidance including an operating method related to the restriction member for resolving an event hindering execution of a job when the event occurs; and restricting the execution of the job until receiving a confirmation instruction indicating that a message regarding the movement of the housing has been confirmed by the user, after the event is resolved based on the guidance when the movement of the housing is involved in resolving the event.

According to the disclosure, it is possible to provide an image forming apparatus and a control method for an image forming apparatus capable of appropriately addressing an event such as a jam that has occurred.

### BRIEF DESCRIPTION OF THE DRAWINGS

FIG. 1 is a diagram illustrating an overall configuration of an image forming apparatus according to a first embodiment.

FIG. 2 is a diagram illustrating a functional configuration of the image forming apparatus according to the first embodiment.

FIG. 3 is a flowchart illustrating a flow of a process according to the first embodiment.

FIGS. 4A to 4D are diagrams illustrating an example of an operation according to the first embodiment.

FIG. 5 is a diagram illustrating an example of an operation according to the first embodiment.

FIG. 6 is a diagram illustrating an example of an operation according to the first embodiment.

FIG. 7 is a diagram illustrating an example of an operation according to the first embodiment.

FIG. 8 is a diagram illustrating an example of an operation according to the first embodiment.

FIG. 9 is a flowchart illustrating a flow of a process according to a second embodiment.

FIG. 10 is a flowchart illustrating a flow of a process according to the second embodiment.

FIGS. 11A to 11D are diagrams illustrating an example of an operation according to the second embodiment.

FIGS. 12A to 12C are diagrams illustrating an example of an operation according to the second embodiment.

FIG. 13 is a diagram illustrating a functional configuration of an image forming apparatus according to a third embodiment.

FIG. 14 is a diagram illustrating a flow of a process according to the third embodiment.

FIGS. 15A to 15C are diagrams illustrating an example of an operation according to a fourth embodiment.

### DETAILED DESCRIPTION OF THE INVENTION

Hereinafter, embodiments of the disclosure will be described with reference to the drawings. In the disclosure, a multifunction peripheral capable of realizing jobs related to copying, faxing, e-mail, and the like in a single housing will be described as one form of an image forming apparatus. In the disclosure, an image forming apparatus is not limited to a multifunction peripheral as long as a configuration is capable of forming an input image based on a print job on paper, and may be a printer, a copier, a fax machine, or the like. Incidentally, the following embodiment is an example for describing the disclosure, and technical content of the description in the claims is not limited to the following description.

A general image forming apparatus interrupts a print job when a paper jam occurs on paper transport during the execution of, for example, the print job, and displays guidance (sometimes called jam guidance) for clearing the paper jam on an operation panel or the like. In the disclosure, an event in which the execution of a print job is hindered by a paper jam that has occurred is called a jam.

To clear the jam that has occurred, a user needs to open a cover openable and closable with respect to a housing (external housing) of an apparatus, or remove a paper feed tray detachable and detachable with respect to the housing of the apparatus depending on a location at which the jam has occurred, to access the inside of the apparatus and remove paper that has caused the paper jam.

In an image forming apparatus of the related art, when a cover opened by the user to clear the jam is closed, the jam guidance ends, display content on the operation panel returns to an execution screen of the print job before the jam occurred, and the print job is automatically resumed.

Incidentally, for example, in a model in which a cover is provided on the rear side of the image forming apparatus, it may be necessary to move the image forming apparatus (to switch the front and rear of the image forming apparatus) in order to open and close the cover. In the case of a model having such a configuration, it is assumed that the user will perform an operation of opening a cover on the rear side to clear a jam after switching the front and rear of the image forming apparatus, closing the open cover, and then returning the image forming apparatus to its original state.

However, as in the related art, when the jam is recognized as being cleared since the rear cover is closed and the print job is resumed, the user may move the image forming apparatus to return the image forming apparatus to its original state while the print job is being executed. When the image forming apparatus is moved after a print job is resumed (while the print job is being executed), this is likely to have an adverse effect on the apparatus or image quality.

In the disclosure, an image forming apparatus capable of appropriately addressing an event such as a jam that has occurred, for example, is realized in the following embodiment.

### 1 First Embodiment

### 1.1 Functional Configuration

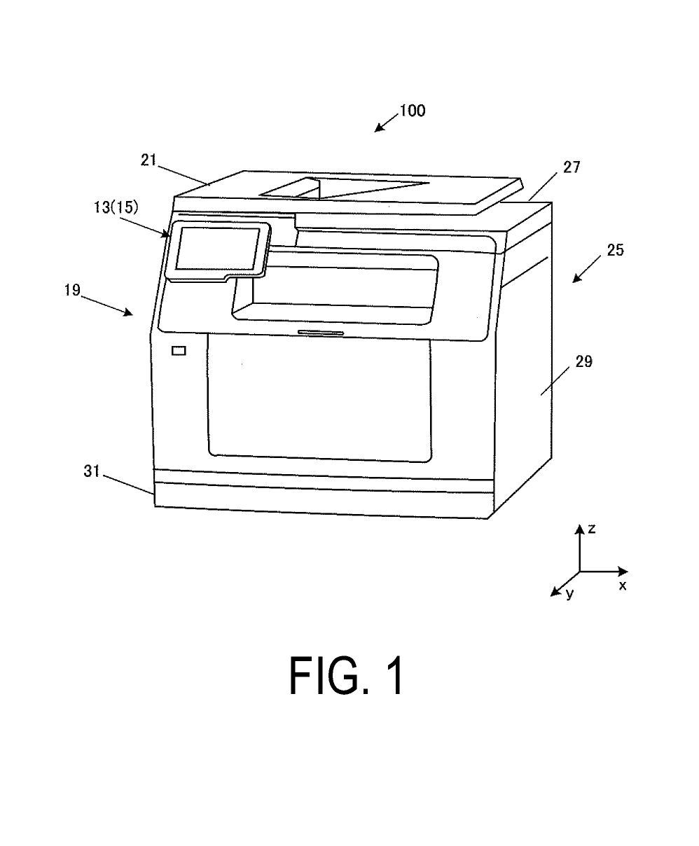

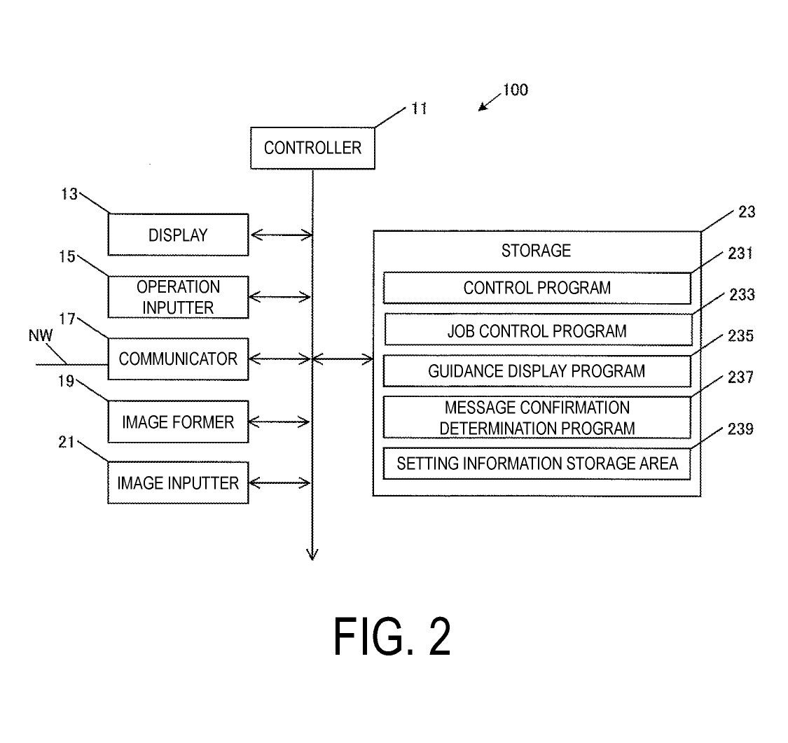

FIG. 1 is an external perspective view illustrating an overall configuration of a multifunction peripheral 100 according to a first embodiment. FIG. 2 is a functional configuration diagram of the multifunction peripheral 100. The multifunction peripheral 100 includes a housing 25 that forms the exterior of the apparatus. The housing 25 is a box-shaped member with a bottom that accommodates at least an image former 19 to be described below and a paper feed (transport) mechanism (not shown) for feeding paper from an attached paper feed tray 31 to the image former 19. The housing 25 is provided with a cover 27 as a cover member configured to be openable and closable with respect to the rear side (-y-axis direction in the figure), and a cover 29 as a cover member configured to be openable and closable with respect to the right side (x-axis direction in the figure). The cover 29 may be provided on the left side (-x-axis direction in the figure) or may be provided on both the left and right sides.

Further, the paper feed tray 31, which is a box-shaped member with an open top for accommodating paper, is provided in a lower portion of the front side of the housing 25 to be freely attached and detached with respect to the front side (a y-axis direction in the figure) of the housing 25. The cover 27 and the cover 29 are restriction members that restrict the user from accessing the inside of the housing 25 when an operation state is a “closed” state, and allow access to the inside of the housing 25 when the operation state is an “open” state. Further, similarly to the cover 27 and the cover 29, the paper feed tray 31 is a restriction member that restricts the user from accessing the inside of the housing 25 when the operation state is a “mounted (stored)” state, and allows the user to access the inside of the housing 25 when the operation state is a “removed” state.

The multifunction peripheral 100 including such a housing 25 includes a controller 11, a display 13, an operation inputter 15, a communicator 17, the image former 19, an image inputter 21, and a storage 23.

The controller 11 comprehensively controls the entire multifunction peripheral 100. The controller 11 can be configured of one or more processing devices (for example, a central processing unit (CPU) or a system on chip (SoC)). The controller 11 realizes functions by reading and executing various programs stored in the storage 23. The controller 11 may be configured of one or more control circuits.

The display 13 displays various types of information to the user. The display 13 can be configured of, for example, a liquid crystal display (LCD) or an organic electro-luminescence (EL) display. The display 13 displays an operation screen in accordance with a state of the multifunction peripheral 100 (for example, a home screen (not shown), an execution screen (operation screen) related to a setting or execution of each job, or jam guidance).

The operation inputter 15 receives information input from the user, or the like. The operation inputter 15 can be configured of, for example, various input devices such as operation keys such as hard keys and software keys, and buttons. The operation inputter 15 can also be configured as a touch panel that allows information to be input via the display 13. When the operation inputter 15 is configured as a touch panel, the operation inputter 15 can detect a user's touch, tap, or swipe operation or the like with respect to an object such as an operation key and an operation button displayed via the display 13, and acquire coordinate information, pressure sensitive information, or the like on the touch panel. As an input scheme for a touch panel, for example, a general scheme such as a resistive film scheme, an infrared scheme, an electromagnetic induction scheme, or a capacitive scheme can be employed.

The communicator 17 includes a wired, wireless, or wired and wireless interface for performing communication with another device via a network NW such as a local area network (LAN), a wide area network (WAN), the Internet, a telephone line, or a fax line. Further, the communicator 17 may include an interface related to (short-range) wireless communication technology, such as Bluetooth (registered trademark), near field communication (NFC), Wi-Fi (registered trademark), ZigBee (registered trademark), infrared data association (IrDA), or wireless USB.

The image former 19 accepts paper from the paper feed tray 31, forms an output image (printed image) based on image data on the paper, and then discharges the paper to a paper discharge tray. The image former 19 can be configured, for example, of a laser printer that employs an electrophotographic scheme. In this case, the image former 19 performs image formation using toner supplied from a toner cartridge (not shown) corresponding to toner colors (for example, cyan, magenta, yellow, and black).

The image inputter 21 can be configured as a scanner device including an automatic document feeder (ADF), a flatbed for placing and reading a document, and the like, in addition to an image sensor such as a charge coupled device (CCD) or a contact image sensor (CIS). A configuration of the image inputter 21 is not particularly limited as long as the image inputter 21 is capable of generating image data by reading a reflected light image from a document image with an image sensor. The image inputter 21 can also be configured as an interface capable of acquiring image data stored in a storage device such as a USB memory and having a file format such as TIFF, BMP, JPEG, or the like, or image data transmitted from an external terminal device (not shown). The image inputter 21 may be configured to generate image data for data transmission by performing, for example, shading correction or density correction on the acquired image data.

The storage 23 is one or more storage devices that store various programs and various pieces of data necessary for an operation of the multifunction peripheral 100. The storage 23 can be configured of, for example, a storage device such as a random access memory (RAM), a solid state drive (SSD), a hard disk drive (HDD), or a read only memory (ROM).

In the first embodiment, the storage 23 stores a control program 231, a job control program 233, a guidance display program 235, and a message confirmation determination program 237, and secures a setting information storage area 239.

The control program 231 is a program that is read by the controller 11 when the multifunction peripheral 100 is controlled in an integrated manner. The controller 11 that has read the control program 231 controls driving of hardware such as the display 13, the operation inputter 15, the communicator 17, the image former 19, and the image inputter 21.

The job control program 233 is a program that the controller 11 reads when executing various jobs, such as a print job including a copy job, a scan job, a fax job, and an image transmission job. The controller 11 that has read the job control program 233 sets an apparatus mode of the multifunction peripheral 100 to a job mode (copy mode, print mode, scan mode, fax mode, image transmission mode, or the like) for executing each job, and executes a job for which an execution instruction has been received. The controller 11 that has read the job control program 233 interrupts the print job that is being executed, for example, when an event such as a jam occurs during the execution of the print job. Further, when the movement of the housing 25 is involved to clear the jam, the controller 11 restricts the resumption (execution) of the interrupted job until the user confirms a message regarding the movement of the housing 25 after the jam has been cleared based on the guidance. Here, the clearing of the jam in the disclosure refers to a state in which the jammed paper has been removed and a factor hindering the execution (resumption) of the print job has been removed, and the clearing of the jam may be subjectively determined by the user or may be mechanically determined by the multifunction peripheral 100 (for example, based on the presence or absence of detection of paper related to the paper jam).

The guidance display program 235 is a program that the controller 11 reads when displaying guidance for resolving an event such as a jam that has occurred. For example, when the event that has occurred is a jam, the controller 11 that reads the guidance display program 235 specifies the location at which the jam has occurred. The controller 11 displays a guidance including a method of operating a restriction member to access a specific location at which the jam has occurred. For example, when a jam has occurred in a location that can be accessed through the cover 27 on the rear side of the multifunction peripheral 100, the controller 11 displays guidance including an operation of opening and closing the cover 27.

The message confirmation determination program 237 is a program that the controller 11 reads when determining whether the user has confirmed a message regarding the movement of the multifunction peripheral 100 displayed after the jam has been cleared, in a case in which the multifunction peripheral 100 needs to move to clear the jam. When the controller 11 that has read the message confirmation determination program 237 determines that a confirmation instruction indicating that the message has been confirmed by the user has been received, the controller 11 determines to resume (execute) the print job interrupted due to the occurrence of the jam.

The setting information storage area 239 is a storage area that stores apparatus setting information of the multifunction peripheral 100, setting information required for the execution of a job, guidance-related information required for displaying of a jam guidance, the message regarding the movement of the multifunction peripheral 100, and the like.

### 1.2 Flow of Process

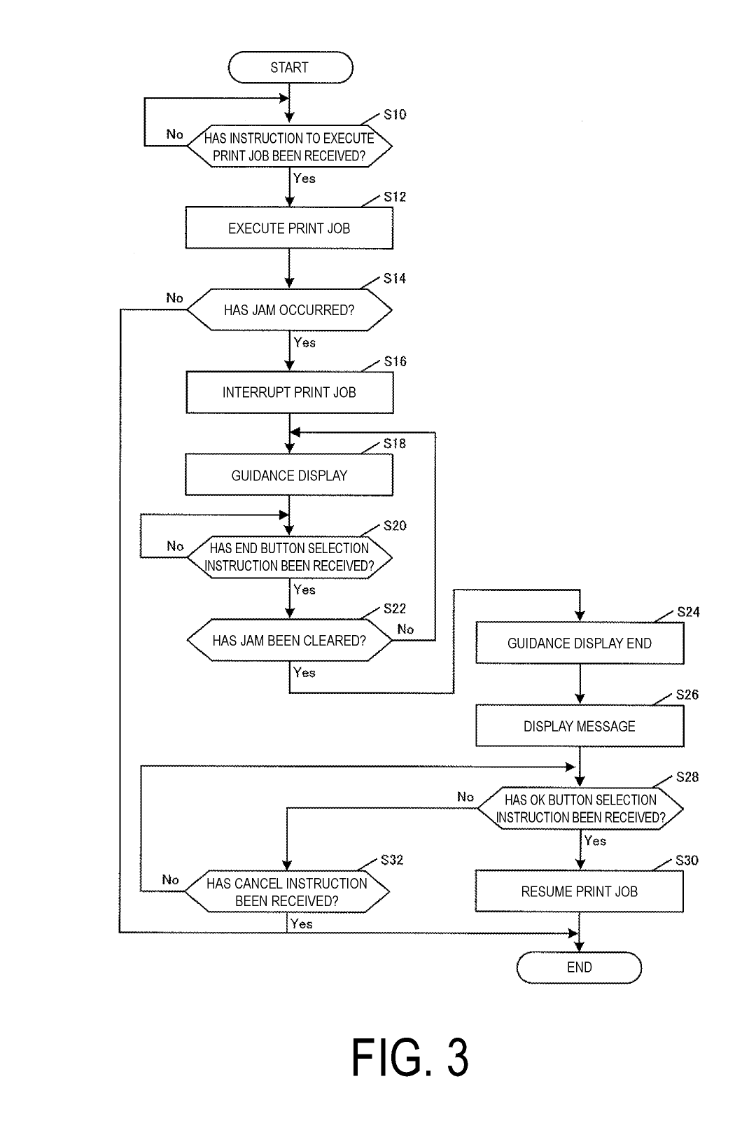

Next, a flow of a process according to the first embodiment will be described with reference to a flowchart in FIG. 3. The process described in FIG. 3 is a process that is executed by the controller 11 of the multifunction peripheral 100 reading the control program 231, the job control program 233, the guidance display program 235, the message confirmation determination program 237, and the like.

When the process starts, the controller 11 determines whether or not an instruction to execute a print job has been received via a print job execution screen (not shown) or the like (step S10).

When the controller 11 determines that the instruction to execute a print job has been received, the controller 11 executes the print job (step S10; Yes → step S12). When the controller 11 determines that the instruction to execute a print job has not been received, the controller 11 waits until the instruction to execute the print job is received (step S10; No).

When the print job is executed, the controller 11 determines whether or not a jam has occurred (step S14). Here, when it is determined that a jam has occurred, the controller 11 interrupts the print job being executed (step S14; Yes → step S16). On the other hand, when it is determined that a jam has not occurred, the controller 11 ends the process (step S14; No → End).

After interrupting the print job, the controller 11 displays guidance for clearing the jam (step S18).

The user accesses the inside of the multifunction peripheral 100 (housing 25) and removes the jammed paper in accordance with the displayed guidance to clear the jam. The controller 11 determines whether or not an instruction to select the End button for receiving an instruction to end the guidance has been received from the user (step S20).

When it is determined that the instruction to select the End button has been received from the user, the controller 11 determines whether or not the jam has been cleared (step S20; Yes → step S22). On the other hand, when it is determined that the instruction to select the End button has not been received from the user, the controller 11 waits until the controller 11 receives the selection instruction (step S20; No).

When it is determined in step S22 that the jam has been cleared, the controller 11 ends the display of the guidance (step S22; Yes → step S24). On the other hand, when it is determined that the jam has not been cleared, the controller 11 continues to display the guidance (step S22; No → step S18).

When the display of the guidance ends in step S24, the controller 11 displays the message regarding the movement of the multifunction peripheral 100 (step S26).

Then, the controller 11 determines whether or not an OK button selection instruction indicating that the user has confirmed the message regarding the movement of the multifunction peripheral 100, has been received on the displayed message (step S28).

When the controller 11 determines that the OK button selection instruction has been received, the controller 11 resumes the print job interrupted in step S16 and ends the process (step S28; Yes → step S30 → End).

Incidentally, when the controller 11 determines that the OK button selection instruction has not been received, the controller 11 determines whether or not an instruction to cancel the print job has been received (step S28; No → step S32). When it is determined that the instruction to cancel the print job has been received, the controller 11 ends the process without resuming the print job (step S32; Yes → End). When it is determined that the instruction to cancel the print job has not been received, the controller 11 returns the process to step S28 (step S32; No → step S28).

### 1.3 Example of Operation

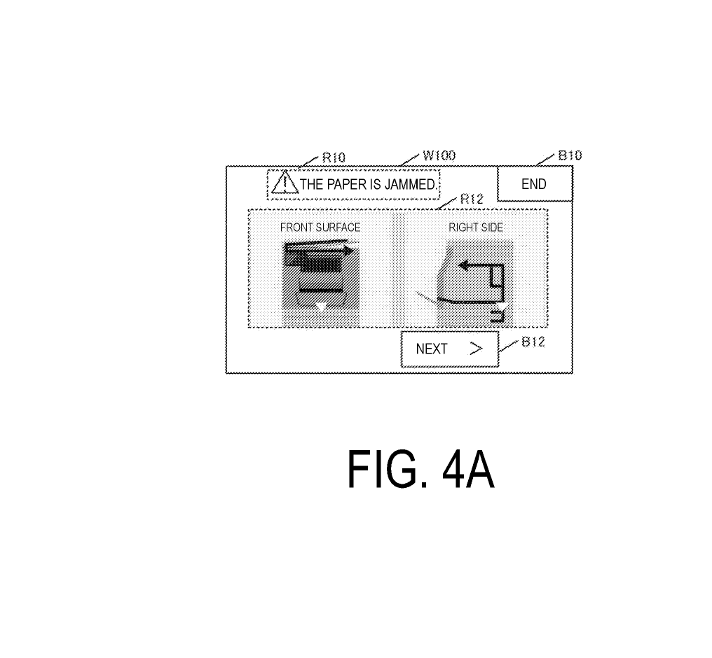

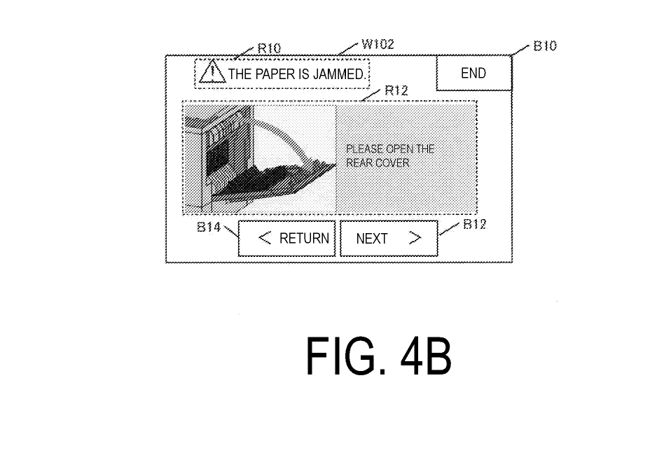

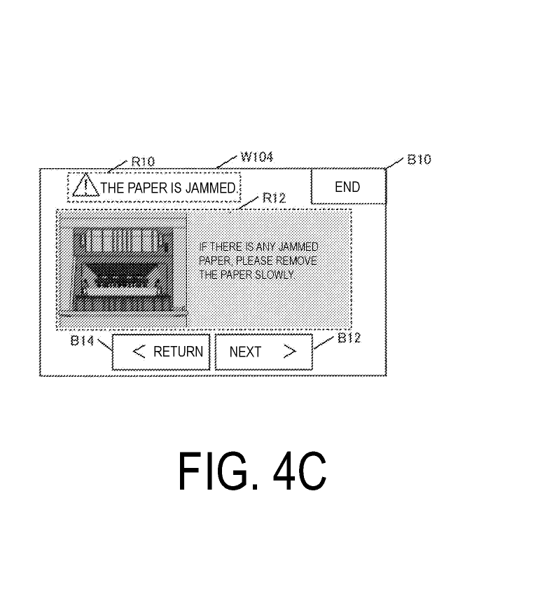

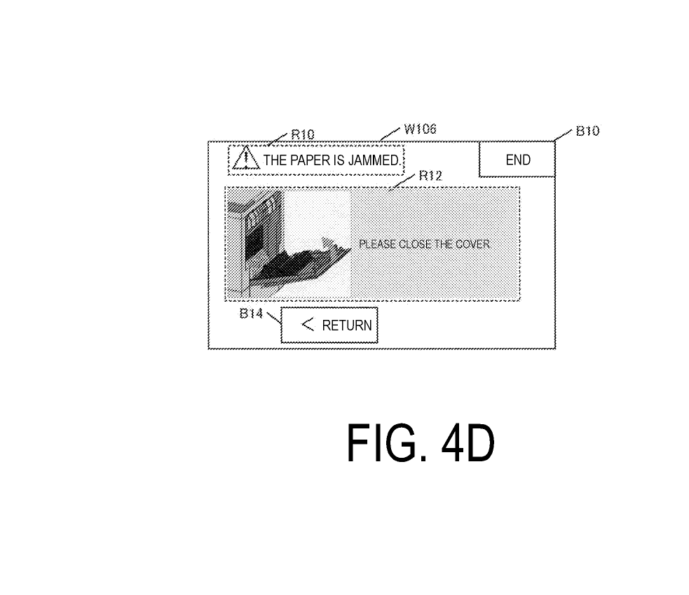

Next, an example of an operation according to the first embodiment will be described. FIGS. 4A to 4D are diagrams illustrating an example of a configuration of the guidance screens W100 to W106 that the controller 11 displays when a jam occurs. The guidance screens W100 to W106 illustrated in FIGS. 4A to 4D are examples of jam guidance provided to the user to clear the jam that has occurred, and are configured so that the jam can be cleared by being operated in accordance with a procedure shown in order of FIGS. 4A, 4B, 4C, and 4D. FIGS. 4A to 4D relate to guidance for clearing the jam through the cover 27 provided on the rear side of the multifunction peripheral 100. In FIGS. 4A to 4D, common components are denoted by the same reference numerals for description.

FIG. 4A illustrates an example of a configuration of the guidance screen W100 that the controller 11 displays after a jam occurs, and is a screen called a jam map. The guidance screen W100 includes an event display region R10 for displaying the content of an event that has occurred, a guidance display region R12 for displaying the content of a guidance, an End button B10, and a Next button B12.

The event display region R10 illustrated in FIG. 4A is an example in which “The paper is jammed,” indicating that the event that has occurred is a jam is displayed. The guidance display region R12 schematically shows a location at which the jam has occurred using a triangular arrow in FIG. 4A. The user can visually check the location at which the jam has occurred by checking a schematic diagram displayed in the guidance display region R12. A schematic diagram illustrating a location at which the jam has occurred may be changed depending on the number of locations at which the jam has occurred (for example, when the number of locations at which the jam has occurred is 1, this may be a single diagram showing either the front or right side where the jam has occurred).

The End button B10 is a button for receiving an instruction to end the guidance from the user. When the controller 11 receives an instruction to select an End button B10 from the user, the controller 11 executes a process related to step S20 and subsequent steps in FIG. 3.

The Next button B12 is a button for receiving a screen transition instruction from the user. When the controller 11 receives an instruction to select the Next button B12 from the user, the controller 11 causes the screen to transition to the guidance screen W102 illustrated in FIG. 4B.

FIG. 4B illustrates an example of the configuration of the guidance screen W102 that the controller 11 displays when receiving an instruction to select the Next button B12 on the guidance screen W100. A display configuration of the guidance screen W102 is obtained by adding a Back button B14 to the guidance screen W100 illustrated in FIG. 4A.

In the guidance display region R12 of the guidance screen W102, a method of operating the cover 27 for accessing the inside of the multifunction peripheral 100 is displayed. FIG. 4B illustrates an example in which a message having content “Please open the rear cover”, and an illustration including the cover 27 and an arrow indicating a direction in which the cover 27 is opened are displayed in the guidance display region R12 as a method of operating the cover 27.

The Back button B14 is a button for receiving the screen transition instruction from the user. When the controller 11 receives an instruction to select the Back button B14 from the user, the controller 11 causes the screen to transition to the guidance screen W100 illustrated in FIG. 4A.

FIG. 4C illustrates an example of a configuration of the guidance screen W104 that the controller 11 displays when receiving an instruction to select the Next button B12 on the guidance screen W102. A display configuration of the guidance screen W104 is the same as that of the guidance screen W102 illustrated in FIG. 4B.

In the guidance display region R12 of the guidance screen W104, a method of accessing the inside of the multifunction peripheral 100 and removing the jammed paper is displayed following the method of operating the cover 27 displayed in the guidance display region R12 of the guidance screen W102. FIG. 4C illustrates an example in which, as a method of removing the paper, a message having content “If there is any jammed paper, please remove the paper slowly” and an illustration including an arrow indicating a direction to remove paper and the paper are displayed in the guidance display region R12.

FIG. 4D illustrates an example of the configuration of a guidance screen W106 that the controller 11 displays when receiving an instruction to select the Next button B12 on the guidance screen W104. Because the guidance screen W106 is a final screen of guidance related to clearing a jam, the Next button B12 illustrated in the guidance screens W100 to W104 is not provided.

In the guidance display region R12 of the guidance screen W106, the method of operating the cover 27 after removing the jammed paper is displayed. FIG. 4D illustrates an example in which a message having content “Please close the cover” and an illustration including the cover 27 and an arrow indicating a direction in which the cover 27 is closed are displayed in the guidance display region R12 as the method of operating the cover 27.

In the first embodiment, even when the user confirms the message content “Please close the cover” displayed in the guidance display region R12 and actually closes the cover 27, the interrupted print job is not resumed until the End button B10 on the guidance screen W106 is selected and an input of an instruction to confirm the message regarding the movement of the multifunction peripheral 100 (the OK button selection instruction) shown in the following figure is received. This configuration makes it possible to prevent adverse effects on the apparatus or image quality when the print job is resumed.

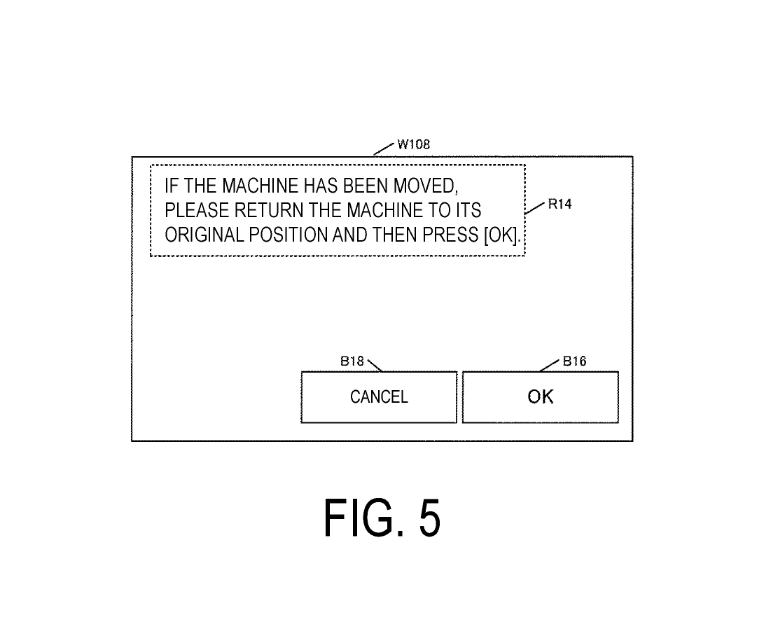

FIG. 5 illustrates an example of a configuration of a message screen W108 that displays the message regarding the movement of the multifunction peripheral 100 that the controller 11 displays when receiving an instruction to select the End button B10 on the guidance screen W106 in FIG. 4D. The user can select the End button B10 on the guidance screens W100 to W104 in FIGS. 4A to 4C, and when the End button B10 is selected on any of the guidance screens W100 to W104 and the paper jam has been cleared at that point in time, the controller 11 ends the jam guidance and displays the message screen W108.

The message screen W108 includes a message display region R14 for displaying “If the machine has been moved, please return the machine to its original position and then press [OK]” as an example of the message regarding the movement of the multifunction peripheral 100, an OK button B16 that receives a selection instruction when the message displayed in the message display region R14 is confirmed by the user, and a Cancel button B18 for receiving an instruction to cancel the interrupted print job.

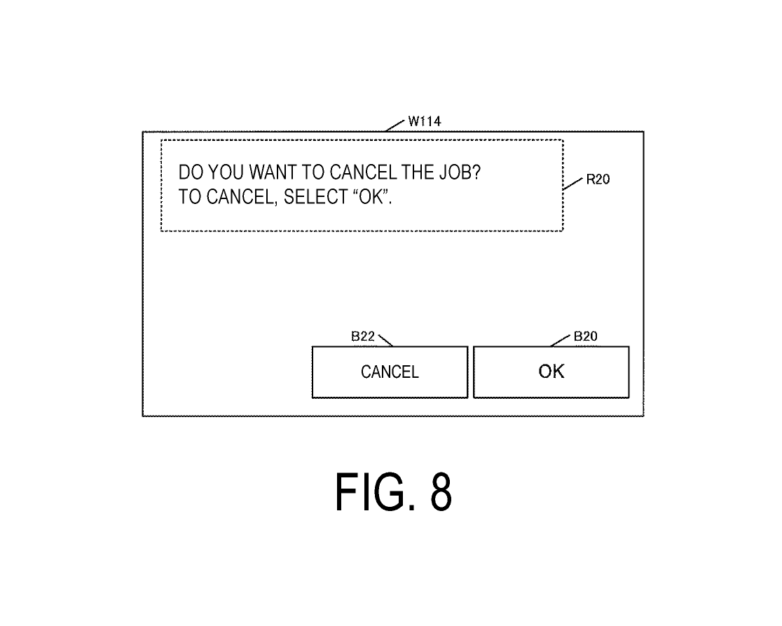

The controller 11 resumes the print job interrupted in step S16 in FIG. 3 when the controller 11 receives an instruction to select the OK button B16 from the user, and cancels the print job interrupted in step S16 in FIG. 3 when the controller 11 receives an instruction to select the Cancel button B18 from the user. The OK button B16 also functions as a button for ending the display of the message screen W108. When the instruction to select the Cancel button B18 has been received, it is also possible to adopt a configuration for displaying an inquiry screen (selection screen) that asks the user whether to cancel or not the interrupted print job, as illustrated in FIG. 8 to be described later, rather than canceling the interrupted print job.

The controller 11 can display the message regarding the movement of the multifunction peripheral 100 in the message display region R14 to alert the user that the multifunction peripheral 100 needs to be returned to its original position when the multifunction peripheral 100 is moved, and reduce the adverse effects on the apparatus or image quality caused by the movement of the multifunction peripheral 100 after the print job is resumed (while the print job is being executed).

Incidentally, regarding the display of the message screen W108 related to displaying of the message regarding the movement of the multifunction peripheral 100, it is possible to adopt a form in which, for example, the operation state of the other cover or paper feed tray (other restriction members) other than the cover that is an operation target in the guidance is determined, a message in accordance with the operation state of the other restriction member is displayed, and then the message screen W108 is displayed.

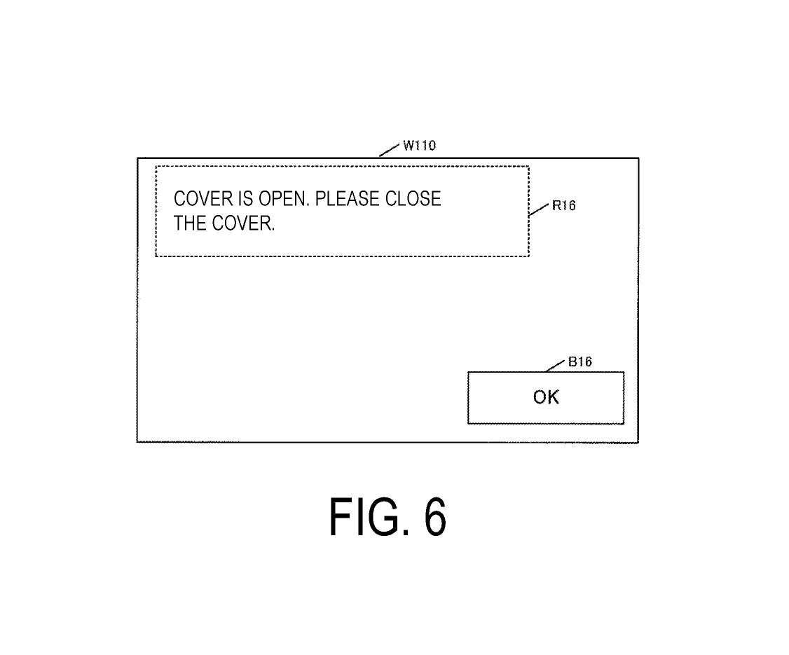

For example, FIG. 6 illustrates an example of a configuration of a message screen W110 that displays a message related to an operation state of other restriction members (for example, the cover 29, the paper feed tray 31, a lower cover which is not shown) other than the cover 27 that is an operation target to clear a jam.

The message screen W110 includes a message display region R16 related to an operation state of another restriction member, and the OK button B16. Since the OK button B16 can be configured in the same way as the OK button B16 provided on the message screen W108 illustrated in FIG. 5, description thereof will be omitted here.

The message display region R16 is a region for displaying messages related to the operation state of the other restriction member, and FIG. 6 illustrates an example in which “Cover is open. Please close the cover” is displayed as the message. When the user confirms the message, closes the cover, and receives the instruction to select the OK button B16, the controller 11 displays the message screen W108 related to the display of the message regarding the movement of the multifunction peripheral 100.

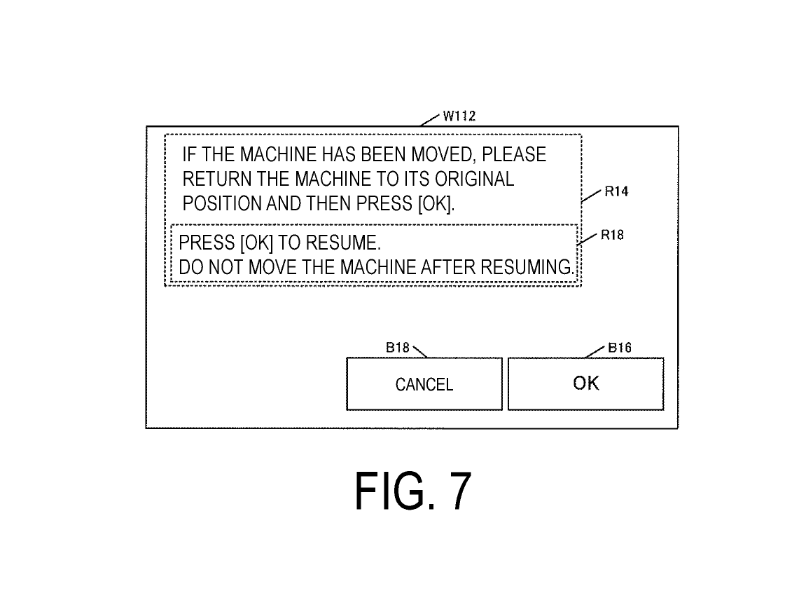

Further, operation content of the multifunction peripheral 100 after the OK button B16 is selected may be displayed in addition to the message regarding the movement of the multifunction peripheral 100. For example, FIG. 7 illustrates an example of a configuration of a message screen W112 in which a display region R18 for displaying the operation content of the multifunction peripheral 100 after the OK button B16 is selected by the user is provided in the message display region R14.

The operation content of the multifunction peripheral 100 after the OK button B16 is selected by the user is displayed in the display region R18. FIG. 7 illustrates an example in which “Press [OK] to resume. Do not move the machine after resuming” is displayed as the operation content of the multifunction peripheral 100.

Thus, the user is notified of operation content of the multifunction peripheral 100 after selecting the OK button B16, so that the user can be caused to imagine how the multifunction peripheral 100 will operate and can be caused to recognize that the multifunction peripheral 100 needs to be returned to an original position before selecting the OK button B16.

Further, when an instruction to select the Cancel button B18 is received in the message screens W108 and W112 illustrated in FIGS. 5 and 7, it is also possible to adopt a configuration for displaying an inquiry screen (selection screen) that asks the user whether to cancel or not the interrupted print job, rather than canceling the interrupted print job.

For example, FIG. 8 illustrates an example of a configuration of an inquiry screen W114 that the controller 11 displays when receiving an instruction to select the Cancel button B18 on any one of the message screens W108 and W112.

The inquiry screen W114 includes an inquiry display region R20 for displaying inquiry content to the user, an OK button B20, and a Cancel button B22. The inquiry display region R20 is a region for displaying inquiry content to the user, and FIG. 8 illustrates an example in which “Do you want to cancel the job? To cancel, select [OK]” is displayed as the inquiry content. The OK button B20 is a button for receiving an instruction to agree to the inquiry content from the user. When the controller 11 receives an instruction to select the OK button B20, the controller 11 cancels the interrupted print job. On the other hand, the Cancel button B22 is a button for receiving an instruction to cancel the inquiry content from the user. When the controller 11 receives an instruction to select the Cancel button B22, the controller 11 causes the screen to transition to the message screen W108 illustrated in FIG. 5.

As described above, according to the first embodiment, even when the jam is cleared and the cover opened to clear the jam is closed, the interrupted print job is not resumed until the End button on the guidance screen is selected and an input of the instruction to confirm the message regarding the movement of the multifunction peripheral 100 (an instruction to select the OK button) is received, thereby making it possible to prevent adverse effects on the apparatus or image quality caused by the movement of the multifunction peripheral after the print job is resumed (while the print job is being executed).

### 2 Second Embodiment

A second embodiment is, for example, an embodiment in which a jam occurs in a plurality of locations (for example, two locations). In the second embodiment, an embodiment in which the jam is continuously cleared through the cover 27 through which the inside of the multifunction peripheral 100 can be accessed from the rear side with respect to the location at which the jam has occurred, and the paper feed tray 31 that can be accessed from the front side of the multifunction peripheral 100 will be described.

Since a functional configuration of the multifunction peripheral 100 according to the second embodiment can be the same as that of the first embodiment, description thereof will be omitted here.

### 2.1 Flow of Process

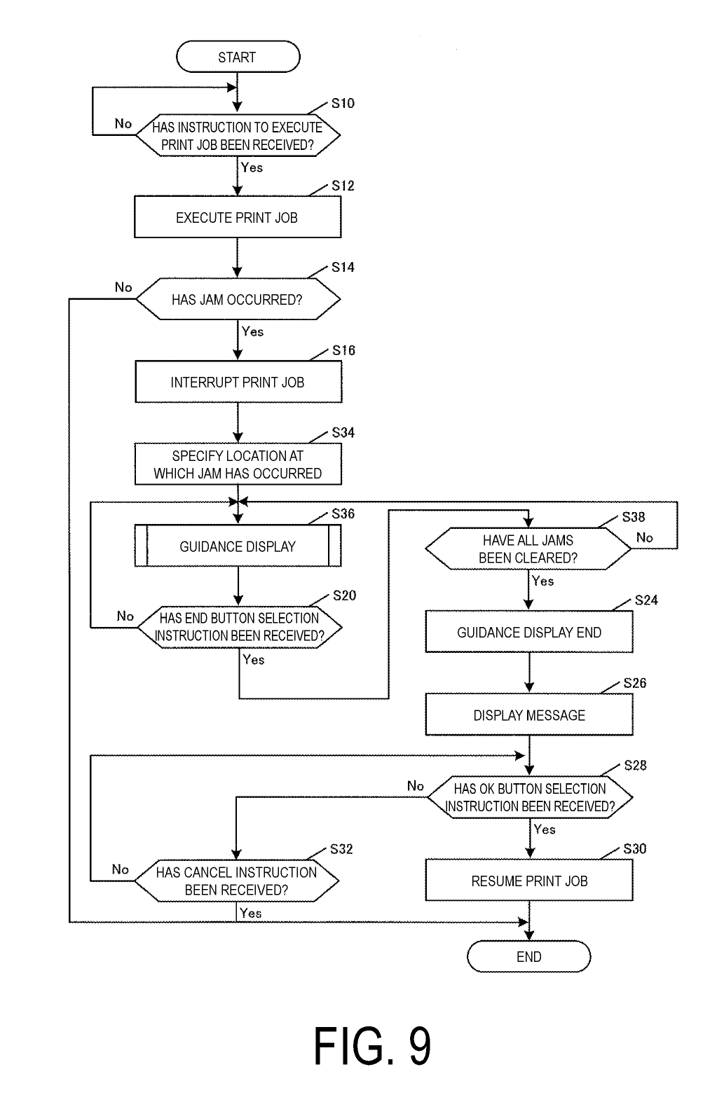

A flow of a process according to the second embodiment in which the flowchart of FIG. 3 according to the first embodiment is replaced with a flowchart of FIG. 9 can be described. Therefore, in FIG. 9, the same processes as those in FIG. 3 are denoted by the same step numbers, and description thereof is omitted.

In step S16, after the print job is interrupted, the controller 11 specifies the location at which the jam has occurred (step S34). Next, the controller 11 displays the guidance (step S36).

The controller 11 determines whether or not the instruction to select the End button has been received from the user (step S20). When the controller 11 determines that the instruction to select the End button has been received from the user, the controller 11 determines whether or not all jams that have occurred have been cleared (step S20; Yes → step S38). When it is determined that the instruction to select the End button has not been received from the user, the controller 11 continues to display the guidance (step S20; No → step S36).

When it is determined that all the jams have been cleared, the controller 11 ends the display of the guidance (step S38; Yes → step S24). On the other hand, when it is determined that all the jams have not been cleared, the controller 11 returns the process to step S36 (step S38; No → step S36).

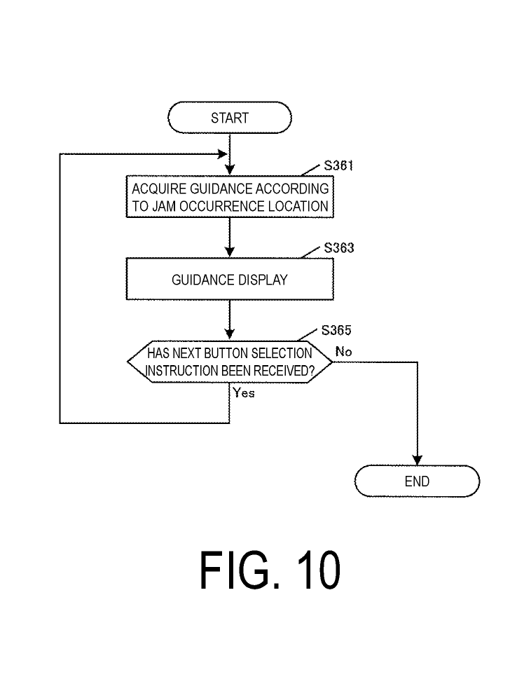

Here, a guidance display process in step S36 in FIG. 9 will be described with reference to a flowchart in FIG. 10. The controller 11 acquires guidance corresponding to the location at which the jam has occurred specified in step S34 in FIG. 9 from the storage 23 (step S361).

Then, the controller 11 displays the guidance acquired in step S361 (step S363). The controller 11 determines whether or not the instruction to select the Next button from the user has been received (step S365). When it is determined that the instruction to select the Next button has been received, the controller 11 returns the process to step S361 (step S365; Yes → step S361). On the other hand, when it is determined that the instruction to select the Next button has not been received, the controller 11 ends the process (step S365; No → End).

Incidentally, FIG. 9 illustrates an example of a process corresponding to a case in which jams have occurred at a plurality of locations, and FIG. 3 illustrates an example of a process corresponding to a case in which a jam has occurred at one location, but the process described in FIG. 9 can be applied even when a jam has occurred at only one location.

### 2.2 Example of Operation

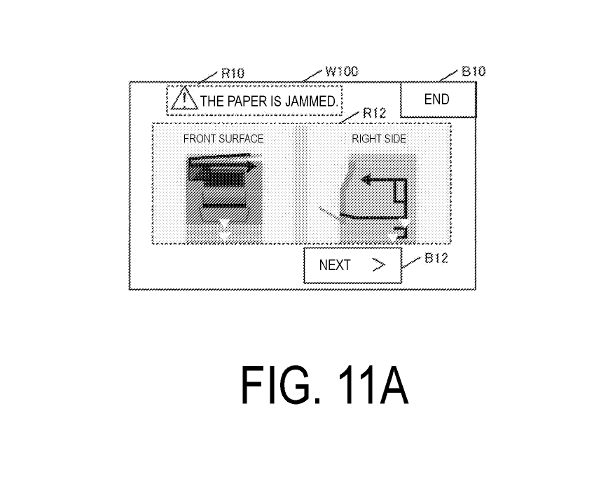

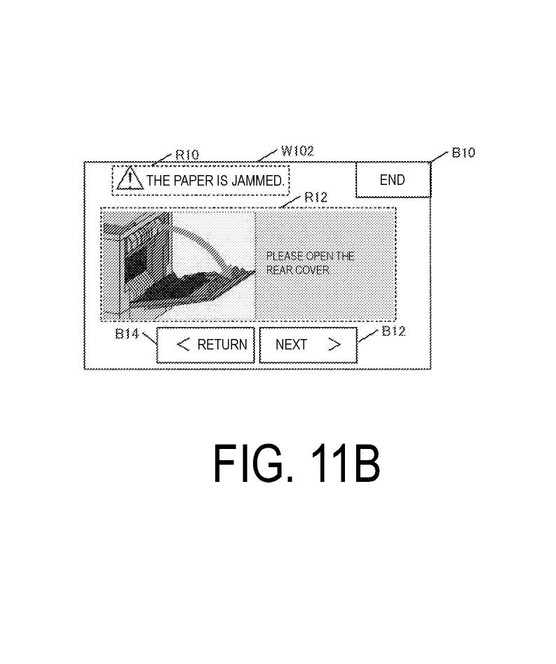

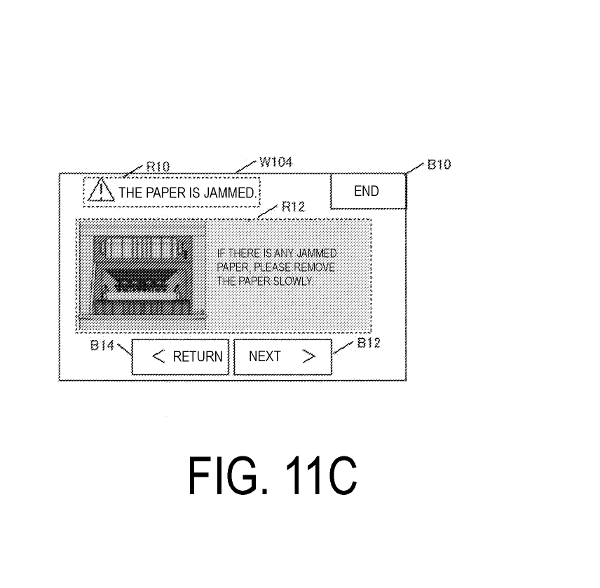

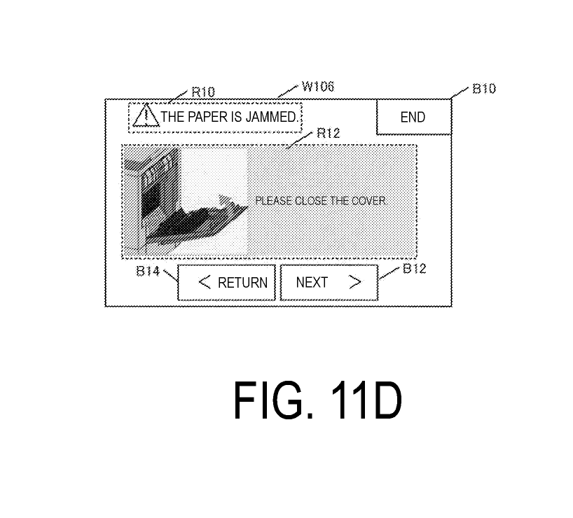

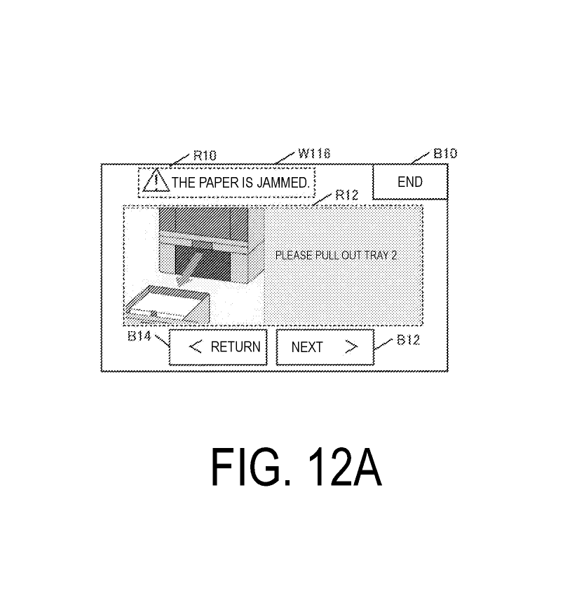

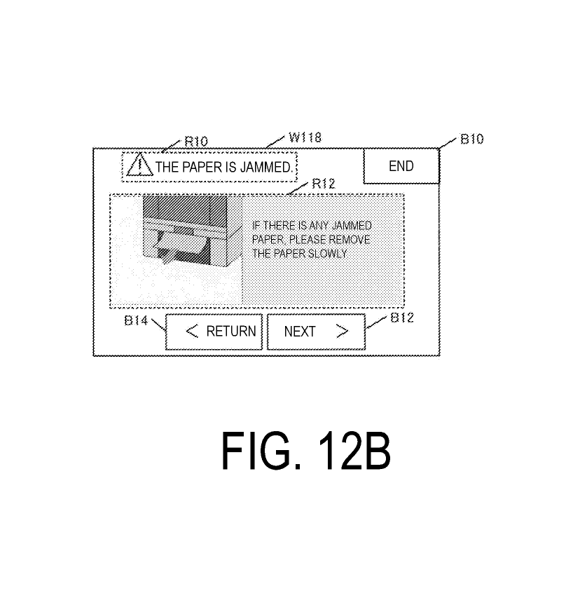

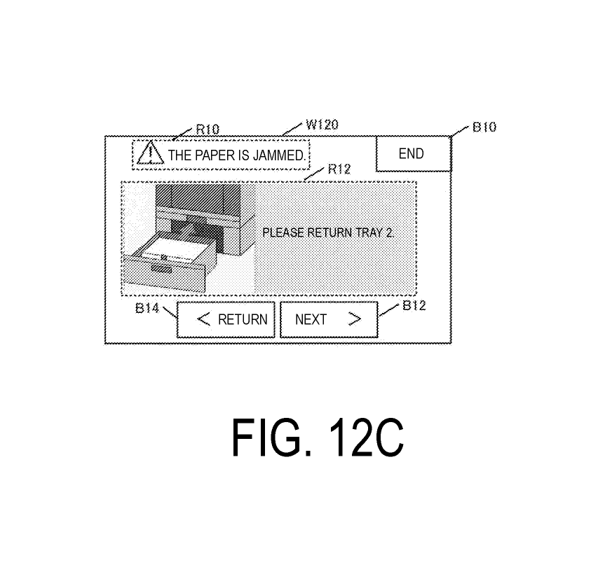

Next, an example of an operation according to the second embodiment will be described. FIGS. 11A to 11D and 12A to 12C are diagrams illustrating an example of a configuration of guidance screens W100 to W120 that the controller 11 displays when jams occur in a plurality of locations (two locations). Here, FIG. 11A is the same as FIG. 4A, except for the number of triangular arrows indicating locations at which the jam has occurred. FIGS. 11B to 11D are diagrams illustrating guidance for accessing the inside of the multifunction peripheral 100 through the cover 27 on the rear side of the multifunction peripheral 100 and clearing a jam, and are the same as the guidance screens W100 to W106 (FIGS. 4B to 4D) illustrated in FIG. 4 of the first embodiment. Also, FIGS. 12A to 12C are guidance screens for accessing the inside of the multifunction peripheral 100 through the paper feed tray 31 on the front side of the multifunction peripheral 100 and clearing a jam.

As in the related art, after an attempt is made to clear the jam through the cover 27 on the rear side of multifunction peripheral 100 (FIGS. 11A to 11D), when an attempt is made to resume the print job without displaying the remaining guidance illustrated in FIGS. 12A to 12C, triggered by the user closing the cover 27, in accordance with the guidance content “Please close the cover” displayed in the guidance display region R12 of the guidance screen W106, the jam guidance is resumed because the jam that is cleared by access from the front side of multifunction peripheral 100 is not addressed, and guidance related to the jam that is cleared by access from the rear side of multifunction peripheral 100 (FIGS. 11A to 11D) is displayed. Here, when the user performs an operation related to clearing the jam through the cover 27 on the rear side of the multifunction peripheral 100 in accordance with the guidance, an attempt is made to resume the print job without displaying the remaining guidance illustrated in FIGS. 12A to 12C, triggered by the user closing the cover 27, but the jam that is cleared by access from the front side of the multifunction peripheral 100 has not been addressed, and therefore, the jam guidance is resumed, and this process is repeated, resulting in a situation in which the print job cannot be resumed. If the user selects the Next button B12 to cause the screen to transition to the guidance screen W116 without performing an operation related to clearing of the jam through the cover 27 on the rear side of the multifunction peripheral 100 when the jam guidance is resumed, the guidance (FIGS. 12A to 12C) related to the jam that is cleared through access from the front side of the multifunction peripheral 100 can be displayed, but even in this case, a problem remains that the guidance illustrated in FIGS. 12A to 12C is not displayed at the time of first guidance display.

On the other hand, in the second embodiment, even when the user closes the cover 27 in accordance with the guidance content displayed in the guidance display region R12 of the guidance screen W106, a process related to the jam guidance does not end unless the instruction to select the End button B10 is received from the user. When the controller 11 receives the instruction to select the Next button B12, the controller 11 causes the screen to transition to the guidance screen W116 illustrated in FIG. 12A.

In the guidance display region R12 of the guidance screen W116, a method of operating the paper feed tray 31 to access the inside of the multifunction peripheral 100 is displayed. FIG. 12A illustrates an example in which a message having content “Please pull out tray 2” and an illustration including the paper feed tray 31 and an arrow indicating a direction in which the paper feed tray 31 is removed are displayed in the guidance display region R12 as a method of operating the paper feed tray 31.

FIG. 12B illustrates an example of a configuration of a guidance screen W118 that the controller 11 displays when receiving an instruction to select the Next button B12 on the guidance screen W116. In the guidance display region R12 of the guidance screen W118, a method of accessing the inside of the peripheral peripheral 100 and removing the jammed paper is displayed, following a method of operating the paper feed tray 31 displayed in the guidance display region R12 of the guidance screen W116. FIG. 12B illustrates an example in which a message having content “If there is any jammed paper, please remove the paper slowly” and an illustration including an arrow indicating a direction to remove paper and the paper are displayed in the guidance display region R12 as a method of removing the paper.

FIG. 12C illustrates an example of a configuration of a guidance screen W120 that the controller 11 displays when receiving an instruction to select the Next button B12 on the guidance screen W118.

In the guidance display region R12 of the guidance screen W120, the method of operating the paper feed tray 31 after removing the jammed paper is displayed. FIG. 12C illustrates an example in which a message having content “Please return tray 2” and an illustration including the paper feed tray 31 and an arrow indicating a direction in which the paper feed tray 31 is mounted are displayed in the guidance display region R12 as the method of operating the paper feed tray 31.

In the second embodiment, even when the message content “Please return tray 2” displayed in the guidance display region R12 is confirmed by the user and the paper feed tray 31 is actually mounted (stored), the interrupted print job is not resumed until the End button B10 of the guidance screen W120 is selected and an input of the instruction to confirm the message regarding the movement of the multifunction peripheral 100 (the OK button selection instruction) illustrated in FIG. 5 is received. With this configuration, it is possible to prevent adverse effects on the apparatus or image quality caused by the movement of the multifunction peripheral after the print job is resumed (while the print job is being executed). Further, in the second embodiment, even when a jam has occurred at a plurality of locations (for example, a first event and a second event), the guidance for resolving the second event can be displayed in succession after the user performs an operation based on the guidance for resolving the first event, and therefore, the user can clear all of the jams that have occurred.

Incidentally, in the second embodiment, a combination of a portion in which the cover 27 on the rear side is open and a portion in which the paper feed tray 31 on the front side is pulled out has been described as an example of the jams that has occurred at a plurality of locations, but the location at which the jam has occurred is not limited thereto, and examples thereof can include (a) a portion in which the cover 27 on the rear side is open and a portion in which the rear cover (not shown) of the paper feed tray 31 is open, and (b) a portion in which the cover 27 on the rear side is open and an automatic document feeder portion.

### 3. Third Embodiment

A third embodiment is an embodiment in which a detector that detects a movement of the multifunction peripheral or a movement of the user is included, and a display of the message regarding the movement of the multifunction peripheral is restricted based on a detection result from the detector.

### 3.1 Functional Configuration

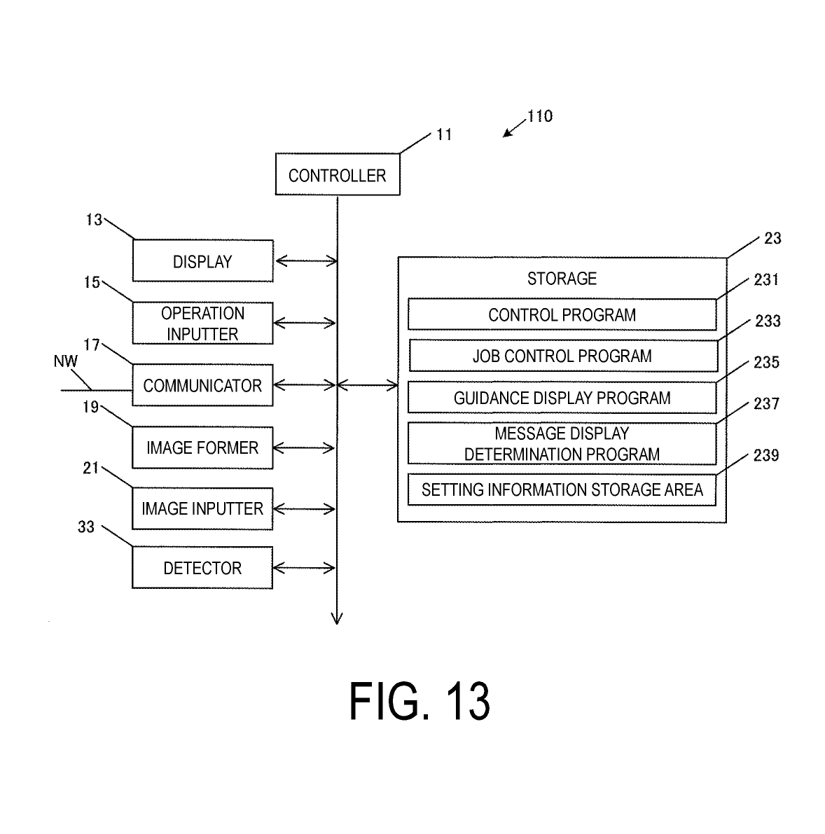

A functional configuration of a multifunction peripheral 110 according to the third embodiment will be described with reference to FIG. 13. FIG. 13 is a diagram illustrating a mechanical configuration of the multifunction peripheral 110. The multifunction peripheral 110 includes a detector 33 in addition to the configuration of the multifunction peripheral 100 according to the first embodiment. Since a configuration other than the detector 33 can be substantially the same as the configuration of the multifunction peripheral 100 according to the first embodiment, description here will be omitted.

The detector 33 is a gyro sensor capable of detecting the movement of the multifunction peripheral 110, a human sensor capable of detecting the movement of the user, or the like. When the detector 33 detects the movement of the multifunction peripheral 110 or the movement of the user, the detector 33 outputs a detection signal to the controller 11. The controller 11 restricts a display of a message related to the movement of the multifunction peripheral 110 based on a detection result from the detector 33. Here, examples of user operations (specific operations) for which the controller 11 restricts a display of messages related to the movement of the multifunction peripheral 110 (housing 25) can include (a) a case in which the user does not move the multifunction peripheral 110, but moves to the rear side of the multifunction peripheral 110 to perform an operation (process) related to clearing the jam, and (b) a case in which the user leans forward from the front side of the multifunction peripheral 110 to perform an operation (process) related to clearing the jam.

### 3.2 Flow of Process

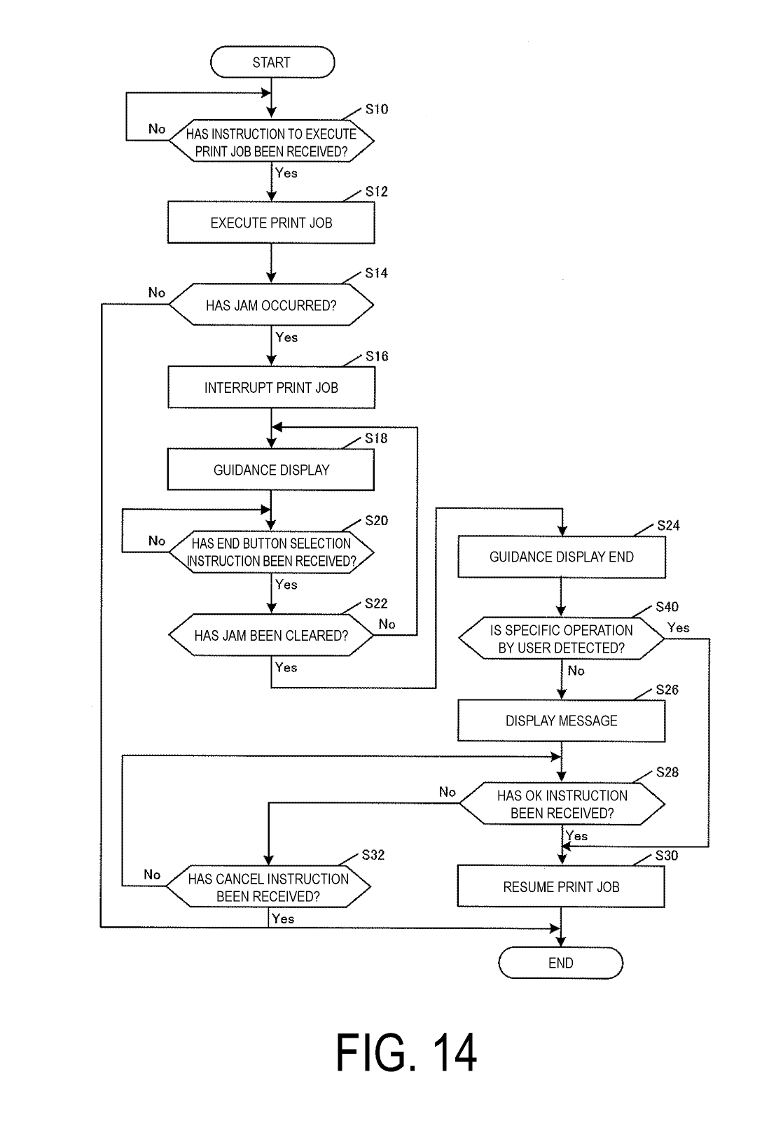

Next, a flow of a process according to the third embodiment will be described using a flowchart in FIG. 14. The process described in the flowchart in FIG. 14 is a process in which step S40 is provided between steps S24 and S26 in FIG. 3.

In step S40, the controller 11 determines whether or not a specific operation of the user has been detected based on the detection result from the detector 33 (step S40). When it is determined that the specific operation of the user has been detected, the controller 11 skips the processes related to steps S26 and S28 and resumes the print job (step S40; Yes → step S30). On the other hand, when it is determined that the specific operation of the user has not been detected, the controller 11 executes the processes of step S26 and subsequent steps (step S40; No → step S26).

Incidentally, the embodiment in which the process related to the detection of the specific operation of the user (step S40) is executed between steps S24 and S26 has been described with reference to FIG. 14, but the process related to step S40 may be executed at any timing after the process related to the interruption of the print job (step S16), and there is no particular restriction.

As described above, according to the third embodiment, when the specific operation of the user has been detected, the display of the message related to the movement of the multifunction peripheral can be restricted, thereby further improving operability in clearing the jam.

### 4 Fourth Embodiment

A fourth embodiment is an embodiment in which, in the first embodiment, the second embodiment, or the like, when opening or closing of the cover 27 on the rear side of the multifunction peripheral 100 (110) is involved to clear a jam that has occurred, a button for receiving a rotation instruction to rotate the display content of the display 13 (operation inputter 15) toward the user and display the display content, or code information indicating the content of the guidance are displayed on the display 13 (operation inputter 15).

### 4.1 Operation Example

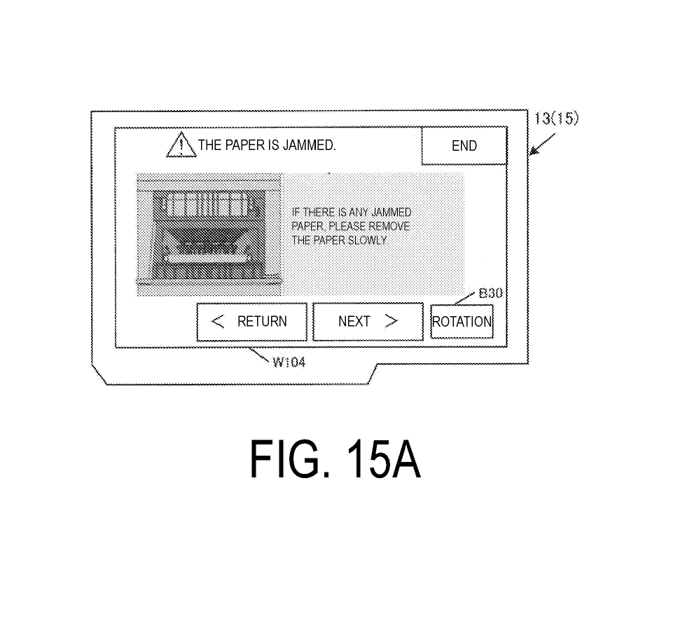

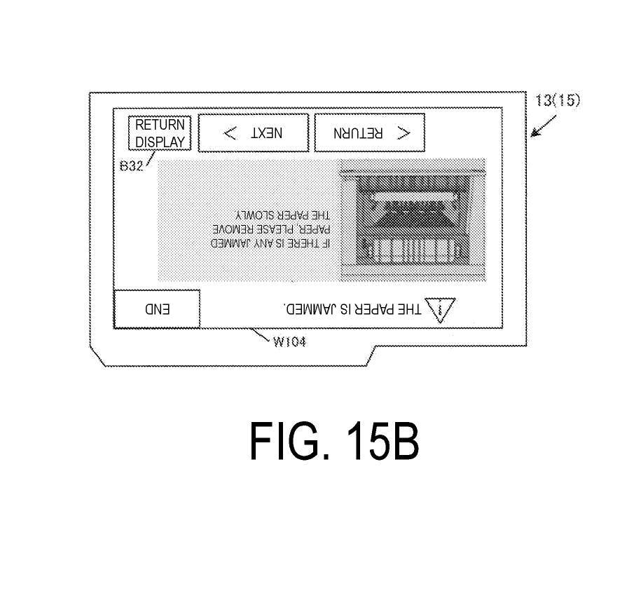

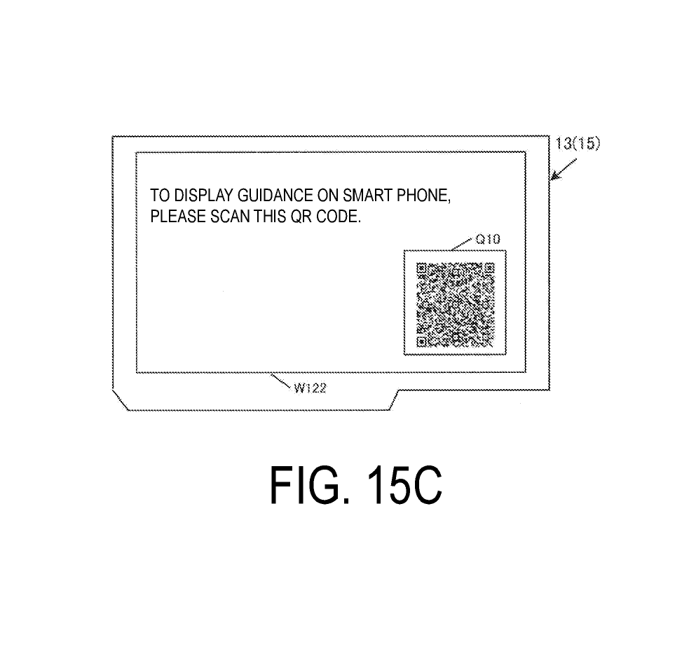

FIG. 15A illustrates an example of a configuration of the guidance screen W104 including a rotation button B30 for receiving a rotation instruction to rotate the guidance content displayed on the display 13 (operation inputter 15) toward the user and display the guidance content.

For example, when or after the user moves to the rear side of the multifunction peripheral 100 (110) to clear the jam that has occurred, the user can rotate and display the display content of the guidance screen W104 by selecting the rotation button B30. FIG. 15B shows a state in which the guidance screen W104 is rotated 180 degrees by the user selecting the rotation button B30. An example of FIG. 15B is an example in which the display content of the guidance screen W104 is rotated 180 degrees by one selection of the rotation button B30, but, for example, the display content of the guidance screen W104 may be rotated to a predetermined rotation angle such as 90 degrees, 180 degrees, 270 degrees, or 360 degrees from a display position (front position) illustrated in FIG. 15A each time the rotation button B30 is selected (pressed). The display content rotated by the selection of the rotation button B30 can be returned to an original display position by the selection of a display return button B32. Further, the display return button B32 may be displayed instead of the rotation button B30 when the guidance screen W104 is rotated by the selection of the rotation button B30. Further, the embodiment in which the display content of the guidance screen W104 can be rotated by selecting the rotation button B30 provided on the guidance screen W104 and displayed has been described with reference to FIGS. 15A and 15B, the embodiment may be, for example, an embodiment in which a mechanical rotation mechanism (not shown) is provided on the display 13 (operation inputter 15), and the display 13 (operation inputter 15) itself is physically rotated so that the display content of the guidance can be rotated.

On the other hand, FIG. 15C illustrates an example of a configuration of a code screen W122 for displaying code information indicating the content of the guidance. The code screen W122 can be called up, for example, by selecting a call button provided on a jam guidance screen, and the call button may be displayed only when a jam that is cleared by access from the rear side of the multifunction peripheral 100 (housing 25) has occurred. For example, when the user tries to clear the jam while looking at an operation screen of a mobile terminal such as a smartphone carried by the user, the user can acquire the display content of the guidance screen by reading the code information Q10 displayed on the code screen W122. In this case, the code information may be a one-dimensional code such as a barcode (for example, EAN code, JAN code, Codbar, or CODE128) or may be a two-dimensional code. The two-dimensional code may be a stack-type two-dimensional code (for example, PDF417 or CODE49) or may be a matrix-type two-dimensional code (for example, Quick Response Code (QR Code (registered trademark)), Data Matrix, VeriCode, or Aztec).

The code information Q10 has embedded address information for accessing a server (not shown; which may be the multifunction peripheral 100 itself) that manages information on the guidance screen. The user can read the address information embedded in the code information using a code information reading function of the smartphone and acquire information on the guidance screen from the server specified by the address information.

Even when the user is located on (moved to) the rear side of the multifunction peripheral 100 (housing 25), the user can clear the jam while referring to the guidance screen displayed on the operation screen of the smartphone, which greatly improves operability when the jam is cleared.

As described above, according to the fourth embodiment, even when opening or closing of the cover on the rear side of the multifunction peripheral is involved to clear the jam that has occurred, the user can perform an operation while checking the guidance screen displayed directly in front of the user, so that the jam can be cleared more efficiently.

The disclosure is not limited to the above-described embodiments, and various modifications can be made. In other words, the technical scope of the disclosure also includes embodiments obtained by combining technical means that are appropriately modified within the scope of the gist of the disclosure.

Further, although the above-described embodiments are described separately for convenience of description, it is obvious that the embodiments may be executed in combination in a technically possible scope.

Further, in the embodiments, a program operating on each device is a program that controls a CPU or the like (a program for causing a computer to function) to realize the functions of the above-described embodiments. Information handled by such a device is temporarily stored in a temporary storage device (for example, a RAM) during the process and then stored in various storage devices such as read only memories (ROMs) and HDDs, and is read, modified, and written by the CPU as necessary.

Here, a computer-readable non-transitory recording medium on which a program is recorded in an information processing device may be any of a semiconductor medium (for example, a ROM or a non-volatile memory card), an optical recording medium/magnetic optical recording medium (for example, a digital versatile disc (DVD), magneto optical disc (MO), mini disc (MD), compact disc (CD), or Blu-ray (BD; registered trademark) disc)), a magnetic recording medium (for example, a magnetic tape or flexible disk), and the like. In this case, the program recorded on the recording medium is read by the computer of the information processing device and executed by the computer, such that not only the functions of the above-described embodiment are realized, but also functions of the disclosure are realized by performing processing in cooperation with an operating system, another application program, or the like based on instructions of the program.

Further, when a program is distributed in a market, the program can be stored in a portable recording medium and distributed, or can be transferred to a server computer connected via a network such as the Internet. In this case, it is obvious that a storage device of the server computer is also included in the disclosure.

Further, each functional block or feature of the device used in the above-described embodiment can also be implemented and executed by an electric circuit, such as an integrated circuit or a plurality of integrated circuits. The electric circuit designed to realize the functions described herein may include a general-purpose processor, a digital signal processor (DSP), an application-specific integrated circuit (ASIC), a field programmable gate array (FPGA), another programmable logic device, a discrete gate or transistor logic, a discrete hardware component, or a combination thereof. The general-purpose processor may be a microprocessor, or any known processor, controller, microcontroller, or state machine. The electric circuit described above may be configured of a digital circuit or may be configured of an analog circuit. Further, when an integrated circuit technology for replacement into a current integrated circuit emerges with the development of semiconductor technology, a new integrated circuit based on the technology may also be used in one or more aspects of the disclosure.

While there have been described what are at present considered to be certain embodiments of the disclosure, it will be understood that various modifications may be made thereto, and it is intended that the appended claims cover all such modifications as fall within the true spirit and scope of the disclosure.

What is claimed is:

1. An image forming apparatus comprising:
a restriction member that restricts user access to the inside of a housing in accordance with an operation state;
a display that displays guidance including an operating method related to the restriction member for resolving an event hindering execution of a job when the event occurs; and
one or more controllers that control the execution of the job,
wherein the one or more controllers restrict the execution of the job until the one or more controllers receive a confirmation instruction indicating that a message regarding the movement of the housing has been confirmed by the user, after the event is resolved based on the guidance when the movement of the housing is involved in resolving the event.

2. The image forming apparatus according to claim 1, wherein the one or more controllers determine whether or not the event has been resolved when receiving an instruction to select an End button for receiving end of an operation based on the guidance from the user, and display the message regarding the movement of the housing when it is determined that the event has been resolved.

3. The image forming apparatus according to claim 2, wherein the one or more controllers determine an operation state of another restriction member other than the restriction member for resolving the event when receiving an instruction to select the End button, and display a message in accordance with the operation state of the other restriction member.

4. The image forming apparatus according to claim 2, wherein the one or more controllers display operation content of the image forming apparatus after the user inputs a confirmation instruction, together with the display of the message regarding the movement of the housing.

5. The image forming apparatus according to claim 2 , wherein the one or more controllers display a selection screen for receiving a selection of whether or not to cancel the execution of the job, together with the display of the message regarding the movement of the housing.

6. The image forming apparatus according to claim 1, wherein, when a first event and a second event hindering the execution of the job occur, the one or more controllers display the guidance for resolving the second event on the display in succession after the user performs an operation based on the guidance for resolving the first event.

7. The image forming apparatus according to claim 1, further comprising a detector that detects movement of the image forming apparatus or movement of the user,wherein the one or more controllers restrict display of the message regarding the movement of the housing based on a detection result from the detector.

8. The image forming apparatus according to claim 1, wherein the one or more controllers display, on the display, an operation button for receiving an instruction to rotate display content on the display or code information indicating the content of the guidance.

9. The image forming apparatus according to claim 1, wherein the restriction member includes a cover member provided on the rear side of the housing to be openable and closable.

10. A control method for an image forming apparatus including a restriction member that restricts user access to the inside of a housing in accordance with an operation state, the method comprising:displaying guidance including an operating method related to the restriction member for resolving an event hindering execution of a job when the event occurs; andrestricting the execution of the job until receiving a confirmation instruction indicating that a message regarding the movement of the housing has been confirmed by the user, after the event is resolved based on the guidance when the movement of the housing is involved in resolving the event.
